(19) United States
(12) Patent Application Publication
(10) Pub. No.: US 2006/0222988 A1
(43) Pub. Date: Oct. 5, 2006

(54) Electrophotographic toner

(75) Inventor: Keiichi Tanida, Osaka (JP)

Correspondence Address: HOGAN & HARTSON L.L.P., 500 S. GRAND AVENUE, SUITE 1900, LOS ANGELES, CA, 90071-2611, US

(73) Assignee: KYOCERA MITA CORPORATION

(21) Appl. No.: 11/393,595

(22) Filed: Mar. 29, 2006

(30) Foreign Application Priority Data
Mar. 31, 2005 (JP) 2005-103619

(51) Int. Cl. G03G 9/08

(52) U.S. Cl. 430/108.6; 430/110.4

(57) ABSTRACT

The electrophotographic toner of the present invention comprises toner particles containing at least a binder resin, wax, a charge control agent and a pigment, and at least titanium oxide externally added to the toner particles as an external additive. The titanium oxide has an aspect ratio of 2 to 5 and a Mohs hardness of not less than 6. It is preferable that the titanium oxide is a compound oxide doped with a metal of the group V of the periodic table and is anatase-type. The electrophotographic toner is especially preferably used for an image forming apparatus having amorphous silicon photoreceptors.

Priority is claimed to Japanese Patent Application No. 2005-103619 filed on Mar. 31, 2005, the disclosure of which is incorporated by reference in its entirety.

### BACKGROUND OF THE INVENTION

1. Field of the Invention

The present invention relates to an electrophotographic toner used to develop an electrostatic latent image in electrophotography method, electrostatic recording method and the like that are adopted for copiers and laser printers.

2. Description of Related Art

Recently, from the viewpoint of ecology & economy (environment-friendly and economic viewpoint), image forming apparatuses such as printers have been required to be composed of longer-life materials. For this reason, regarding photoreceptors for example, amorphous silicon photoreceptors having good friction durability have become the mainstream. However, while amorphous silicon photoreceptors have good friction durability, ion products produced on the surface of the photoreceptors are less easily removed and therefore the ion products trap moisture at high temperature and high humidity, causing image deletion.

A countermeasure that has been taken against this is to treat the surface of toner with an external additive such as titanium oxide, let the external additive function as an abrasive and remove moisture absorbed in the surface of amorphous silicon photoreceptors by polishing.

However, titanium oxide externally added to the toner as an abrasive has larger specific gravity than silica that is a typical external additive. Consequently, titanium oxide that has relatively large particle size is apt to separate from the surface of the toner, and titanium oxide that has relatively small particle size is buried in the toner by stress during mixing and agitation in a developing machine and does not fulfill its original function as an external additive, deteriorating image quality.

As a measure against this problem, Japanese Unexamined Patent Publication No. 2001-117265 proposes an electrophotographic toner wherein titanium oxide having an aspect ratio of 2 to 12, preferably, 5 to 10 is used as an external additive. According to this document, the use of the above-mentioned titanium oxide improves adherability of titanium oxide to toner particles and reduces scumming and filming.

However, even if the aspect ratio of titanium oxide is in the range described in Japanese Unexamined Patent Publication No. 2001-117265, it is sometimes impossible to sufficiently attain the effect of inhibiting the separation of titanium oxide. In addition, titanium oxide not only has problems of separating from toner particles and being buried in toner particles but also is required to further improve the effect of polishing the surface of photoreceptors. In particular, since anatase-type titanium oxide has wide lattice spacing and low hardness, the problem arises that the effect of polishing photoreceptors such as amorphous silicon photoreceptors is low.

### SUMMARY OF THE INVENTION

The advantage of the present invention is to provide an electrophotographic toner that inhibits titanium oxide from separating and being buried, has the high effect of polishing the surface of photoreceptors and makes it possible to obtain a good image stably for a long period of time.

After being dedicated to research to solve the above problem, the present inventor has achieved the present invention, finding the fact that when titanium oxide externally added to toner particles has an aspect ratio of 2 to 5, titanium oxide is inhibited from separating and being buried and that when the titanium oxide has a Mohs hardness of not less than 6, the titanium oxide can exhibit the high effect of polishing.

The electrophotographic toner of the present invention comprises toner particles containing at least a binder resin, wax, a charge control agent and a pigment, and at least titanium oxide externally added to the toner particles as an external additive. The titanium oxide has an aspect ratio of 2 to 5 and a Mohs hardness of not less than 6.

According to the present invention, since the aspect ratio of titanium oxide as an external additive is a predetermined value, titanium oxide is inhibited from separating and being buried. In addition, since the Mohs hardness of the titanium oxide is a predetermined value, the titanium oxide can exhibit the high effect of polishing. As a result, it is possible to obtain stable image quality for a long period of time as well as in the initial stage and attain the effect of excellent durability.

### BRIEF DESCRIPTION OF THE DRAWINGS

FIG. 1 is a graph showing the distribution of equivalent particle size of toner particles.

### DETAILED DESCRIPTION OF PREFERRED EMBODIMENTS

The electrophotographic toner of the present invention comprises toner particles containing at least a binder resin, wax, a charge control agent and a pigment, and at least titanium oxide externally added to the toner particles as an external additive.

(Binder Resin)

The type of binder resin used for the toner of the present invention is not especially limited and for example, thermoplastic resins such as styrene resin, acrylic resin, styrene-acrylic copolymer, polyethylene resin, polypropylene resin, vinyl chloride resin, polyester resin, polyamide resin, polyurethane resin, polyvinyl alcohol resin, vinyl ether resin, N-vinyl resin and styrene-butadiene resin are preferably used.

Specifically, polystyrene resin may be a homopolymer of styrene or a copolymer of styrene and other copolymerizable monomers. Examples of the copolymerizable monomers include p-chlorostyrene; vinylnaphthalene; ethylene unsaturated monoolefins such as ethylene, propylene, butylene and isobutylene; vinyl halides such as vinyl chloride, vinyl bromide and vinyl fluoride; vinyl esters such as vinyl acetate, vinyl propionate, vinyl benzoate and vinyl butyrate; (meth)acrylic ester such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate and butyl methacrylate; other acrylic acid derivatives such as acrylonitrile, methacrylonitrile and acrylamide; vinyl ethers such as vinyl methyl ether and vinyl isobutyl ether; vinyl ketones such as vinyl methyl ketone, vinyl ethyl ketone and methyl isopropenyl ketone; and N-vinyl compounds such as N-vinyl pyrrole, N-vinyl carbazole, N-vinyl indole and N-vinyl pyrrolidone. One kind of these may be used alone, or a combination of two or more kinds of these may be copolymerized with a styrene monomer.

Polyester resin obtained through condensation polymerization or condensation copolymerization of an alcohol component and a carboxylic component can be used. Examples of components used in synthesizing polyester resin are as follows. Examples of a dihydric alcohol component or a trihydric or polyhydric alcohol component include diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexane dimethanol, dipropylene glycol, polyethylene glycol, polypropylene glycol and polytetramethylene glycol; bisphenols such as bisphenol A, hydrogenated bisphenol A, polyoxyethylene bisphenol A and polyoxypropylene bisphenol A; and trihydric or polyhydric alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylol propane and 1,3,5-trihydroxy methylbenzene.

Examples of a dicarboxylic component or a tricarboxylic or polycarboxylic component include dicarboxylic acids, tricarboxylic acids, and anhydrides or lower alkyl esters of these acids, specifically, dicarboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, malonic acid, or alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid and isododecenyl succinic acid; and tricarboxylic or polycarboxylic acids such as 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butane tricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid and empol trimer acid. Polyester resin has a softening point of 110 to 150° C., preferably 120 to 140° C.

The binder resin may be thermoset resin. The adoption of partial cross-linked structure makes it possible to further improve the storage stability, shape maintainability or durability of toner without deteriorating fixability. Therefore, 100 parts by weight of thermoplastic resin does not need to be used as a binder resin for toner and it is also preferable that a cross-linking agent is added or thermoset resin is partly used.

The thermoset resin is exemplified by epoxy resin or cyanate resin, more specifically, one kind or a combination of two or more kinds of bisphenol A type epoxy resin, hydrogenated bisphenol A type epoxy resin, novolac type epoxy resin, polyalkylene ether type epoxy resin, alicyclic epoxy resin and cyanate resin.

In the present invention, the binder resin preferably has a glass transition point (Tg) of 50 to 65° C., more preferably, 50 to 60° C. When the glass transition point is lower than the above range, the toner to be obtained is fused each other in a developing machine, lowering storage stability. In addition, because of low resin strength, toner is apt to adhere to photoreceptors. Moreover, when the glass transition point is higher than the above range, the low-temperature fixability of toner is deteriorated.

The glass transition point of the binder resin can be figured out from the point of variation in specific heat, using a differential scanning calorimeter (DSC). Specifically, the endothermic curve is measured, using a differential scanning calorimeter DSC-6200 manufactured by Seiko Instruments Inc. as a measuring device. This endothermic curve is obtained by putting 10 mg of a measurement sample in an aluminum pan, using an empty aluminum pan as reference and conducting measurement at normal temperature and normal humidity with a measurement temperature range of 25 to 200° C. and a temperature raising rate of 10′/minute. The glass transition point is figured out from the endothermic curve so obtained.

(Wax)

The wax used to improve fixability and anti-offset property is not specially limited, and for example, polyethylene wax, polypropylene wax, Teflon (registered trademark) wax, Fischer-Tropsch wax, paraffin wax, ester wax, montan wax and rice wax are preferably used. Two or more kinds of the wax may be used together. By adding such wax, it is possible to more efficiently prevent offset property or image smearing (a smear around the image when the image is rubbed).

The above-mentioned wax has no special limitation, and it is preferable to contain 1 to 10 parts by weight of the wax to the total amount of the binder resin. When the amount of added wax is less than 1 part by weight, offset property and image smearing cannot be efficiently prevented. Meanwhile, when the amount of added wax is more than 10 parts by weight, the toner is apt to be fused each other, lowering storage stability.

(Charge Control Agent)

The charge control agent is contained in order to significantly improve a charge level and charge rise characteristics (the index of chargeability to a certain charge level in a short period of time) and attain excellent characteristics in durability and stability. In other words, when the toner is positively charged for development, a positively chargeable charge control agent can be added. When the toner is negatively charged for development, a negatively chargeable charge control agent can be added.

The charge control agent is not specially limited. Specific examples of the positively chargeable charge control agent include azine compounds such as pyridazine, pyrimidine, pyrazine, orthooxazine, metaoxazine, paraoxazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline and quinoxaline; direct dyes composed of an azine compound such as azine fast red FC, azine fast red 12BK, azine violet BO, azine brown 3G, azine light brown GR, azine dark green BH/C, azine deep black EW and azine deep black 3RL; nigrosine compounds such as nigrosine, nigrosine salts and nigrosine derivatives; acid dyes composed of a nigrosine compound such as nigrosine BK, nigrosine NB and nigrosine Z; metal salts of naphthenic acid or higher fatty acid; alkoxylated amine; alkylamide; quaternary ammonium salts such as benzylmethyl hexyldecyl ammonium and decyl trimethyl ammonium chloride. Only one kind or a combination of two or more kinds of these can be used. In particular, the use of nigrosine compounds as positively chargeable toner is the most suitable in order to attain faster rise characteristics.

In addition, resin or oligomer having quaternary ammonium salt, carboxylate or a carboxyl group as a functional group can be used as positively chargeable charge control agent. Specific examples include one kind, or two or more kinds of styrene resin having quaternary ammonium salt, acrylic resin having quaternary ammonium salt, styrene-acrylic resin having quaternary ammonium salt, polyester resin having quaternary ammonium salt, styrene resin having carboxylate, acrylic resin having carboxylate, styrene-acrylic resin having carboxylate, polyester resin having carboxylate, polystyrene resin having a carboxyl group, acrylic resin having a carboxyl group, styrene-acrylic resin having a carboxyl group and polyester resin having a carboxyl group.

In particular, styrene-acrylic resin having quaternary ammonium salt as a functional group is the most suitable in order to easily adjust the charge amount to a value within the desired range. In this case, examples of the acrylic comonomer preferable to be copolymerized with the above styrene unit include alkyl(meth)acrylate ester such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate and iso-butyl methacrylate. As quaternary ammonium salt, a unit derived from dialkyl amino alkyl(meth)acrylate through the process of quaternization is used. Examples of the derived dialkyl amino alkyl (meth)acrylate include di(lower alkyl) aminoethyl(meth)acrylate such as dimethylaminoethyl(meth)acrylate, diethylaminoethyl(meth)acrylate, dipropylaminoethyl(meth)acrylate and dibutylaminoethyl(meth)acrylate; dimethyl methacrylamide, and dimethylaminopropyl methacrylamide. A polymerizable monomer containing a hydroxyl group, such as hydroxyethyl (meth)acrylate, hydroxypropyl(meth)acrylate, 2-hydroxybutyl(meth)acrylate and N-methylol (meth)acrylamide can be combined in polymerization.

As a negatively chargeable charge control agent, for example, organometallic complex and chelate compound are effective. Examples include aluminum acetylacetonate, iron (II) acetylacetonate and 3,5-di-tert-butylsalicylic acid chrome. Especially, acetylacetone metallic complex, salicylic acid metallic complex or salt are preferable. In particular, salicylic acid metallic complex or salicylic acid metallic salt are preferable.

The above-mentioned positively or negatively chargeable charge control agent may be contained in the toner in an amount of 1.5 to 15 parts by weight, preferably, 1.5 to 8.0 parts by weight, more preferably, 1.5 to 7.0 parts by weight to the total amount of the binder resin. When the amount of added charge control agent is smaller than the above range, it becomes difficult to stably charge the toner to a predetermined polarity. When an image is formed by developing an electrostatic latent image with this toner, there is a tendency of image density and durability in image density to be deteriorated. In addition, the charge control agent is subject to poor dispersion, which can cause so-called fog and severe contamination of photoreceptors. On the other hand, when the amount of added charge control agent is larger than the above range, resistance to environment may be lowered. In particular, poor charging or image defect may occur at high temperature and high humidity, causing such defects as contamination of photoreceptors.

(Pigment)

The coloring agent that is a pigment is not specially limited. Examples of a black coloring agent include carbon black such as acetylene black, lamp black and aniline black. Examples of a magenta coloring agent include C.I. Pigment Red 81, C.I. Pigment Red 122, C.I. Pigment Red 57, C.I. Pigment Red 49, C.I. Solvent Red 49, C.I. Solvent Red 19, C.I. Solvent Red 52, C.I. Basic Red 10 and C.I. Disperse Red 15 that are described in the Color Index. Examples of a cyan coloring agent include C.I. Pigment Blue 15, C.I. Pigment Blue 15-1, C.I. Pigment Blue 16, C.I. Solvent Blue 55, C.I. Solvent Blue 70, C.I. Direct Blue 86 and C.I. Direct Blue 25 that are described in the Color Index. Examples of a yellow coloring agent include nitro pigments such as Naphthol Yellow S, azo pigments such as Hansa Yellow 5G, Hansa Yellow 3G, Hansa Yellow G, Benzidine Yellow G and Vulcan Fast Yellow 5G or inorganic pigments such as iron oxide yellow and yellow ocher. Examples of a yellow coloring agent also include C.I. Pigment Yellow 180, C.I. Solvent Yellow 2, C.I. Solvent Yellow 6, C.I. Solvent Yellow 14, C.I. Solvent Yellow 15, C.I. Solvent Yellow 16, C.I. Solvent Yellow 19 and C.I. Solvent Yellow 21 that are described in the Color Index. One kind or a combination of two or more kinds of these coloring agents can be used. These coloring agents are contained in an amount of 2 to 20 parts by weight, preferably, 3 to 10 parts by weight to the total amount of the binder resin.

(Titanium Oxide)

The electrophotographic toner of the present invention comprises titanium oxide externally added as an external additive, and the titanium oxide has an aspect ratio of 2 to 5. This makes it possible to inhibit the separation and burial of titanium oxide. In contrast, the aspect ratio of less than 2 makes it easier for titanium oxide to be separated and buried. The aspect ratio of more than 5 inhibits titanium oxide from being buried but reduces adhesion force to toner particles, easily causing separation.

The aspect ratio in the present invention represents a ratio of a major axis to a minor axis, which is a value calculated by the following formula (I).
Aspect ratio=Major axis/Minor axis (I)

The major and minor axes may have a value which allows titanium oxide to function as an external additive. In the present invention, particularly, the major axis may be 0.010 to 0.150 μm, preferably, 0.020 to 0.120 μm while the minor axis may be 0.002 to 0.050 μm, preferably, 0.005 to 0.040 μm. The aspect ratio may have the predetermined relationship within these ranges. The major and minor axes in the above formula (I) are a value obtained by measuring titanium oxide with a transmission electron microscope. The aspect ratio is the average of the values calculated by respectively measuring the major and minor axes of 100 pieces of titanium oxide and applying the resultant values to the above formula (I).

Titanium oxide in the present invention has a Mohs hardness (Mohs hardness number) of not less than 6. This makes it possible for titanium oxide to attain the high effect of polishing. By contrast, the Mohs hardness of less than 6 makes it impossible to attain a given effect of polishing. The Mohs hardness stands for a number that semi-quantitatively represents hardness of a solid object, depending on whether there is a scratch or not after scratching the surface of the solid object, and it is expressed by a numeric value of 1 (soft) to 10 (hard) (Michinori Ohki and three others, “Kagaku jiten”, Tokyo Kagaku Dozin Co., Ltd., Oct. 1, 1996, page 1447). The Mohs hardness in the present invention is a value obtained by attaching titanium oxide to a pestle used for a mortar with a piece of two-sided tape, scratching the after-mentioned materials well known for Mohs hardness with the pestle and then judging whether a scratch is observed on the surface of the well known materials under a stereomicroscope.

To set the aspect ratio and the Mohs hardness at a predetermined value, the titanium oxide may be a compound oxide doped with a metal of the group V of the periodic table and may be anatase-type. When the metal of the group V of the periodic table is used as a doping metal for titanium oxide, titanium oxide crystals turn linear anatase-type. As mentioned above, because of wide lattice spacing and low hardness, anatase-type titanium oxide has the low effect of polishing. However, the anatase-type titanium oxide obtained by being doped with the metal is apt to have high hardness and consequently can demonstrate the high effect of polishing. Furthermore, when the aspect ratio is a predetermined value, the separation and burial of titanium oxide can be inhibited, thereby making it possible to obtain the high effect of polishing photoreceptors.

Examples of the metal of the group V of the periodic table include vanadium, niobium and tantalum. In the present invention, in particular, vanadium and/or niobium are preferably used. The amount of the doping metal to be added may be not less than 1 mol % to less than 10 mol %, preferably 1 to 5 mol % to the total amount of titanium oxide. On the contrary, when the amount of the doping metal to be added is out of the above-mentioned range, it is not preferable because of the possibility that the aspect ratio of titanium oxide may be out of the range of the predetermined value.

As described above, by selecting the aforementioned aspect ratio and Mohs hardness of titanium oxide, it becomes possible to properly retain titanium oxide on the toner surface. It is also possible to judge whether to retain titanium oxide in proper conditions, by analyzing the rate of free titanium oxide separated from the toner surface and the rate of free toner particles which do not retain a proper amount of titanium oxide because of its separation and burial in the toner surface. It is preferable that the rate of free titanium oxide and the rate of free toner particles are respectively not more than 10%.

These rates can be measured, for example, by using a particle analyzer (“DP-1000” manufactured by Horiba, Ltd.). With the particle analyzer, it is possible to put fine particles such as toner one by one into high-temperature thermal nonequilibrium plasma and obtain elements, the number of particles and the particle size from emission spectra of fine particles accompanying the excitation.

Specifically, “rate of free titanium oxide” is a value calculated by measuring with a particle analyzer the emission frequency of a Ti atom derived from titanium oxide and the emission frequency of a Ti atom that emits light simultaneously with a carbon atom which is a constituent element of the binder resin and applying each value so obtained to the following formula (II).
Rate of free titanium oxide (%)=100×[A/(A+B)] (II)

A: Emission frequency of Ti atom only

B: Emission frequency of Ti atom that emits light simultaneously with carbon atom

“Rate of free toner particles” represents a ratio of the toner particles to the surface of which no titanium oxide adheres to all toner particles. For example, the rate of free toner particles (%) can be found out as follows.

The height of emission spectra of the particle analyzer stands for the intensity of the emission. The intensity of the emission is proportional not to the size and form of a particle but to the atomic number of the element (carbon atom, Ti) contained in a particle. To express the emission intensity of the element as particle size, when each emission intensity of toner particles (carbon atom: C) and titanium oxide (Ti) is obtained, assuming that the emission intensity of toner particles (C) and the emission intensity of titanium oxide (Ti) are respectively a perfectly spherical particle composed of toner particles (C) only and a perfectly spherical particle composed of titanium oxide (Ti) only, each of the perfectly spherical particles is expressed as the particle size of toner particles (C) and the particle size of titanium oxide (Ti). At this time, the perfectly spherical particles are called an equivalent particle and its particle size is called equivalent particle size.

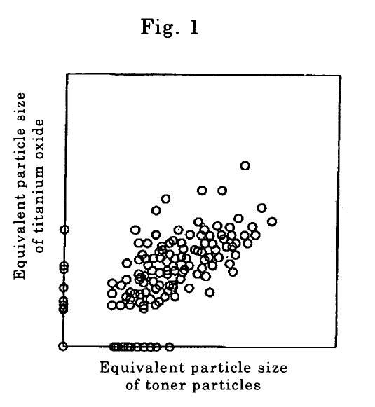

Since titanium oxide is very small, it is difficult to detect its particles one by one. For this reason, analysis is made by adding emission signals of other external additives than the detected titanium oxide and converting into one equivalent particle. Thus, when the equivalent particle size of equivalent particles obtained from the respective emission spectra of toner particles and the external additives is plotted for each toner particle, the distribution chart of equivalent particle size of toner particles can be obtained as shown in FIG. 1.

In FIG. 1, the horizontal axis indicates the equivalent particle size of toner particles and the vertical axis indicates the equivalent particle size of titanium oxide. The equivalent particles on the horizontal axis represent the toner particles to which no titanium oxide adheres. In this case, toner particles to which an external additive that falls short of a predetermined density of titanium oxide adheres are also represented on the horizontal axis or in the vicinity thereof, and these toner particles are also included in the toner particles to which no titanium oxide adheres. The value obtained by calculating the ratio of the toner particles to which no titanium oxide adheres to all toner particles is referred to as “rate of free toner particles”.

As different analysis from free toner, a degree of burial of titanium oxide in the toner surface can be found out in order to grasp whether a proper amount of titanium oxide is retained on the toner surface or not.

The degree of burial is figured out as follows. That is, the surface of a toner prepared for supply is observed at a magnification of 30,000 under a scanning electron microscope (SEM: “JSM-7401F” by JEOL); surface analysis, as elemental analysis, is carried out with an energy dispersive X-ray analyzer (“EK-23000BU” by EDAX); the composition ratio of titanium is measured in units of toners; and the average value of 50 toners is figured out (X1). Next, the toner in a developing machine is collected after a printing test of 100,000 sheets of paper; surface analysis is carried out again with the above energy dispersive X-ray analyzer; and the average composition ratio of titanium of 50 toners is figured out (X2).

The value calculated by applying the aforementioned X1 and X2 to the following formula (III) is defined as a degree of burial.
Degree of burial (%)=100×[1−(X2/X1)] (III)

The degree of burial is the value including titanium oxide which separates from the toner surface and does not exist. The degree of burial is preferably not more than 50%.

The conditions of measurement with a scanning electron microscope (SEM) and an energy dispersive X-ray analyzer can be exemplified by the following.
SEM: Applied voltage=15 kV, Magnification=30,000
Energy dispersive X-ray analyzer: For analysis, the emission current of SEM is set at 20 μA, and the detection sensitivity is set at 1000 to 5000 cps (mPa·s), adjusting irradiation current.

Next, in order to ensure that the surface of titanium oxide keeps preferable, the added amount of the titanium oxide is preferably 0.2 to 5.0 parts by weight, more preferably, 0.5 to 3.0 parts by weight to 100 parts by weight of toner particles. On the other hand, when the added amount is smaller than the above range, the effect of polishing is reduced, causing dielectric breakdown of the photoreceptor surface and defects in forming a thin layer as well as contamination of photoreceptors. In addition, when the added amount is larger than the above range, titanium oxide does not adhere firmly to the surface of the toner and the rate of free titanium oxide rises, which may possibly lead to negative effects on image characteristics such as fog and defects in forming a thin layer.

In providing hydrophobicity, it is preferable that the titanium oxide undergoes surface treatment with a hydrophobizing agent. Thereby, a variety of toner performance can be stably shown in response to environmental changes, especially, change in humidity. A hydrophobizing agent for this surface treatment is not specially limited and it is exemplified by a titanate coupling agent and other various heretofore known agents. In contrast, if the titanium oxide is used as an external additive without hydrophobization treatment, defects such as significant deterioration in image density may possibly occur, for example, in the environment of high humidity.

In the present invention, titanium oxide is used as an external additive. In order to improve mobility, storage stability and cleanability, besides the above titanium oxide, fine particles (normally, having a mean particle size of not more than 1.0 μm) such as colloidal silica and hydrophobic silica may be added. To 100 parts by weight of toner particles, 0.2 to 10.0 parts by weight of the above silica is used.

(Manufacturing Method)

Anatase-type titanium oxide having a predetermined aspect ratio and Mohs hardness can be manufactured as follows, for example. First, a peroxotitanic acid solution is prepared using titanium powder, and then a metal of the group V of the periodic table is added as a doping metal to this solution. Subsequently, through hydrothermal treatment at 80 to 100° C. for about 7 to 15 hours, peroxo-modified anatase sol is obtained. The hydrothermal time of 7 hours or shorter may possibly make the Mohs hardness of titanium oxide lower than a predetermined value. The hydrothermal time of 15 hours or longer is not preferable because it means more hydrothermal treatment than necessary.

Then, the sol so obtained is dried at about 50 to 100° C. for about 1 to 10 hours in an oven. This makes it possible to obtain anatase-type titanium oxide that is doped with the above metal and that has a predetermined aspect ratio and Mohs hardness.

Next, the method for manufacturing the electrophotographic toner of the present invention will be illustrated. First, additives such as a binder resin, wax, a charge control agent and a pigment are mixed by a predetermined compounding ratio, and toner particles are prepared through each process of melting and kneading, pulverization, classification and the like. Then, titanium oxide having a predetermined aspect ratio and Mohs hardness is externally added to the toner particles, thereby obtaining the electrophotographic toner of the present invention. The toner particles so obtained may have a mean particle size of about 5 to 10 μm. The mean particle size of toner particles can be measured, for example, using Multisizer 3 (manufactured by Beckman Coulter K.K.).

Titanium oxide can be externally added by mixing and agitating titanium oxide particles and toner particles, for example, with a Henschel mixer, a V-shaped mixer, a Turbula mixer, a hybridizer, a rocking mixer and the like.

The electrophotographic toner obtained as above may be used for a one-component development method employing the toner alone as a developer and may be used for a two-component development method employing the mixture of a toner and a carrier as a developer.

The one-component development method is exemplified by a magnetic one-component development method using magnetic force to transport a toner and a non-magnetic one-component development method using electrostatic force to transport a toner. When used for a magnetic one-component development method, in addition to the above-mentioned components, magnetic powder may be contained in the toner particles.

As magnetic powder materials, heretofore known materials can be used. Specific examples include ferromagnetic metals or alloys such as iron including ferrite and magnetite, cobalt and nickel, compounds containing these elements, alloys that contain no ferromagnetic elements but show ferromagnetism through proper heat treatment, or chromium dioxide. The magnetic powder that undergoes surface treatment with a surface treatment agent such as a titanium coupling agent and a silane coupling agent can be used. The amount of magnetic powder to be contained may be 10 to 100 parts by weight, preferably, 20 to 80 parts by weight to the total amount of the binder resin.

When used for the two-component development method, the electrophotographic toner of the present invention and a carrier are mixed and agitated to be a developer. The amount of the toner to be added may be 1 to 20 parts by weight, preferably, 3 to 15 parts by weight to 100 parts by weight of the carrier. The carrier may have a mean particle size of about 20 to 100 μm. The mean particle size of the carrier can be measured with a laser scattering particle size analyzer, for example, a model LA-700 manufactured by Horiba, Ltd. To mix and agitate a toner and a carrier, mixers such as a ball mill, a nauta mixer and a rocking mixer can be used.

As the carrier, particles composed of a metal such as iron, iron oxide, reduced iron, ferrite, magnetite, nickel and cobalt, their alloy or oxide, or particles in which fine particles of each of the above materials are dispersed in the binder resin can be used. In order to provide enough chargeability, it is preferable that the surface of these particles is covered with resin. Examples of the resin to coat the surface of the particles include styrene-acrylic resin, acrylic resin, styrene resin, silicon resin, acrylic modified silicon resin and fluorine resin. Examples of the method to coat the surface of the particles with resin include fluidized bed spray drying method and dipping method.

The above-mentioned electrophotographic toner of the present invention is especially preferably used for an image forming apparatus having amorphous silicon photoreceptors. Amorphous silicon (a-Si) constituting the photoreceptors may be a-SiC, a-SiO and a-SiON as well as a-Si.

The present invention will be described in detail below, with reference to examples and comparative examples. It is understood, however, that the examples are for the purpose of illustration and the invention is not to be regarded as limited to any of the specific materials or condition therein.

### EXAMPLES

<Production of Titanium Oxide>

### Example A of Producing Titanium Oxide

15 ml of ammonia water and 65 ml of hydrogen peroxide solution were mixed and 0.01 mol of titanium powder was put into the mixed solution, followed by agitation and melting at 30° C. for four hours. Then, using cation-exchange resin, ammonium ions were removed and 0.01 ml/L of peroxotitanic acid solution was obtained. In addition, as a doping metal, 2 mol % of niobium was added to the peroxotitanic acid solution. Subsequently, through hydrothermal treatment at 100° C. for 8 hours, peroxo-modified anatase sol was prepared. The sol so obtained was dried at 80° C. for 6 hours in an oven, thereby obtaining titanium oxide A. The titanium oxide A so obtained had a minor axis of 0.020 μm and a major axis of 0.092 μm.

### Example B of Producing Titanium Oxide

In the same manner as Example A of producing titanium oxide, 0.01 ml/L of peroxotitanic acid solution was obtained. Then, instead of 2 mol % of niobium, as a doping metal, 2 mol % of vanadium was added to the solution. Except this, titanium oxide B was obtained in the same manner as Example A of producing titanium oxide. The titanium oxide B so obtained had a minor axis of 0.010 μm and a major axis of 0.031 μm.

### Example C of Producing Titanium Oxide

In the same manner as Example A of producing titanium oxide, 0.01 ml/L of peroxotitanic acid solution was obtained. Then, instead of 2 mol % of niobium, as a doping metal, 4 mol % of niobium was added to the solution. Except this, titanium oxide C was obtained in the same manner as Example A of producing titanium oxide. The titanium oxide C so obtained had a minor axis of 0.020 μm and a major axis of 0.042 μm.

### Example D of Producing Titanium Oxide

In the same manner as Example A of producing titanium oxide, 0.01 ml/L of peroxotitanic acid solution was obtained. Then, instead of 2 mol % of niobium, as a doping metal, 1 mol % of vanadium was added to the solution. Except this, titanium oxide D was obtained in the same manner as Example A of producing titanium oxide. The titanium oxide D so obtained had a minor axis of 0.010 μm and a major axis of 0.050 μm.

### Example E of Producing Titanium Oxide

In the same manner as Example A of producing titanium oxide, 0.01 ml/L of peroxotitanic acid solution was obtained. Then, instead of 2 mol % of niobium, as a doping metal, 10 mol % of niobium was added to the solution. Except this, titanium oxide E was obtained in the same manner as Example A of producing titanium oxide. The titanium oxide E so obtained had a minor axis of 0.020 μm and a major axis of 0.022 μm.

### Example F of Producing Titanium Oxide

In the same manner as Example A of producing titanium oxide, 0.01 ml/L of peroxotitanic acid solution was obtained. Then, instead of 2 mol % of niobium, as a doping metal, 0.8 mol % of vanadium was added to the solution. Except this, titanium oxide F was obtained in the same manner as Example A of producing titanium oxide. The titanium oxide F so obtained had a minor axis of 0.011 μm and a major axis of 0.064 μm.

### Example G of Producing Titanium Oxide

In the same manner as Example A of producing titanium oxide, 0.01 ml/L of peroxotitanic acid solution was obtained. Then, as a doping metal, 2 mol % of niobium was added to the solution. Subsequently, hydrothermal treatment was carried out at 100° C. for 6 hours, instead of at 100° C. for 8 hours. Except this, titanium oxide G was obtained in the same manner as Example A of producing titanium oxide. The titanium oxide G so obtained had a minor axis of 0.020 μm and a major axis of 0.094 μm.

Regarding titanium oxide in Examples A to G of producing titanium oxide, the aspect ratio and the Mohs hardness were measured. The measuring method is as follows and the results are presented in Table 1.

(Aspect Ratio)

The major and minor axes of 100 pieces of titanium oxide obtained as above were respectively measured under a transmission electron microscope. The results were applied to the above formula (I), and the values so obtained were averaged.

(Mohs Hardness)

Measurement was made by attaching the titanium oxide obtained as above to a pestle used for a mortar with a piece of two-sided tape, scratching the materials well known for Mohs hardness with the pestle and then judging whether a scratch was observed on the surface of the titanium oxide under a stereomicroscope. The following is the materials well known for Mohs hardness.

Mohs hardness 1: Talc

Mohs hardness 2: Gypsum

Mohs hardness 3: Calcite

Mohs hardness 4: Fluorite

Mohs hardness 5: Apatite

Mohs hardness 6: Orthoclase Feldspar

Mohs hardness 7: Quartz

Mohs hardness 8: Topaz

Mohs hardness 9: Corundum

Mohs hardness 10: Diamond

TABLE 1

| | Doping | | Aspect | Mohs |
|---|---|---|---|---|
| Titanium oxide | metal | Type | ratio | hardness |
| Titanium oxide A | niobium | anatase | 4.6 | 6 |
| Titanium oxide B | vanadium | anatase | 3.1 | 6 |
| Titanium oxide C | niobium | anatase | 2.1 | 7 |
| Titanium oxide D | niobium | anatase | 5.0 | 6 |
| Titanium oxide α: | — | rutile | 1.6 | 7 |
| TTO-55A (Ishihara | | | | |
| Sangyo Kaisha Ltd.) | | | | |
| Titanium oxide E | niobium | anatase | 1.1 | 7 |
| Titanium oxide F | vanadium | anatase | 5.8 | 6 |
| Titanium oxide G | niobium | anatase | 4.7 | 5 |

### Example 1

<Production of Electrophotographic Toner>

100 parts by weight of polyester resin (obtained through condensation reaction of bisphenol A and fumaric acid)

5 parts by weight of carbon black (product name “Pr-90” manufactured by Cabot corp.)

4 parts by weight of Fischer-Tropsch wax (product name “FT-100” manufactured by Nippon Seiro Co., Ltd.)

2 parts by weight of quaternary ammonium salt compound (product name “P-51” manufactured by Orient Chemical Industries, Ltd.)

By the above compounding ratio, each component was mixed and agitated in a Henschel mixer, and then melted and kneaded with a biaxial extrusion machine to prepare a resin composition for toner. The obtained resin composition for toner was pulverized with an air pulverizer and classified with an air classifier, thereby obtaining toner particles having a volume average particle size of 8 μm. To 100 parts by weight of the toner particles, 1.0 part by weight of silica particles (product name “TG-820” manufactured by Cabot corp.) and 1.0 part by weight of the titanium oxide A obtained as above were added and mixed at 3000 rpm for 10 minutes in a Henschel mixer, thereby obtaining an electrophotographic toner.

Next, the electrophotographic toner obtained as above was mixed with a ferrite carrier (product name “EF-60B” manufactured by Powdertech Co., Ltd.) having a mean particle size of 80 μm the surface of which was coated with silicone resin (product name “SR2115” manufactured by Toray Silicone Co., Ltd.), so that the toner concentration could be 5% by weights. Then, through mixing and agitation uniformly, a two-component developer was obtained.

### Example 2

Except that instead of the titanium oxide A, the titanium oxide B was used, an electrophotographic toner was prepared in the same manner as Example 1, thereby obtaining a two-component developer.

### Example 3

Except that instead of the titanium oxide A, the titanium oxide C was used, an electrophotographic toner was prepared in the same manner as Example 1, thereby obtaining a two-component developer.

### Example 4

Except that instead of the titanium oxide A, the titanium oxide D was used, an electrophotographic toner was prepared in the same manner as Example 1, thereby obtaining a two-component developer.

### Comparative Example 1

Except that instead of the titanium oxide A, titanium oxide a (product name “TTO-55A” manufactured by Ishihara Sangyo Kaisha Ltd.) shown in Table 1 was used, an electrophotographic toner was prepared in the same manner as Example 1, thereby obtaining a two-component developer.

### Comparative Example 2

Except that instead of the titanium oxide A, the titanium oxide E was used, an electrophotographic toner was prepared in the same manner as Example 1, thereby obtaining a two-component developer.

### Comparative Example 3

Except that instead of the titanium oxide A, the titanium oxide F was used, an electrophotographic toner was prepared in the same manner as Example 1, thereby obtaining a two-component developer.

### Comparative Example 4

Except that instead of the titanium oxide A, the titanium oxide G was used, an electrophotographic toner was prepared in the same manner as Example 1, thereby obtaining a two-component developer.

<Evaluation>

Then, image density, image deletion and image quality were evaluated when 100,000 sheets of paper were continuously printed, using two-component developers obtained in Examples 1 to 4 and Comparative Examples 1 to 4. For evaluation, a color printer “LS-5016N” manufactured by Kyocera Mita Corp. with amorphous silicon (a-Si) photoreceptors was used. Each evaluation method is as follows and the results are presented in Table 2.

(Image Density)

In the initial stage of printing, image evaluation patterns (black solid image) were printed with the above page printer and this was defined as initial image density. Then, image samples in the initial stage and after printing 100,000 sheets of paper were measured with a densitometer (“RD-191” manufactured by GretagMacbeth). The criterion for evaluation was set as follows. After the initial stage, image evaluation patterns were printed and evaluated in units of 1,000 sheets of paper, checking a sudden change.

∘: Image density of 1.3 or more

x: Image density of less than 1.3

(Image Deletion)

The image samples after printing 100,000 sheets of paper to evaluate image density were visually observed and evaluated in terms of image uniformity. The criterion for evaluation was set as follows.

∘: No image deletion is observed.

x: Image deletion is observed.

(Image Quality)

The image evaluation patterns printed to evaluate image density were sampled for every 1,000 sheets of paper and visually observed and evaluated in terms of image uniformity.

TABLE 2

| | Titanium oxide | | Rate (%) | | | Image density | | | | Image deletion | | |
|---|---|---|---|---|---|---|---|---|---|---|---|---|
| | | Mohs | Free | | Degree | | | (After printing | | (After printing | | |
| | Aspect | hard- | titanium | Free | of burial | (Initial | | 100,000 sheets | | 100,000 sheets | | |
| | ratio | ness | oxide | toner | (%) | stage) | | of paper) | | of paper) | Image quality | Remarks |
| Example | 4.6 | 6 | 7.2 | 7.0 | 33.0 | 1.5 | ◯ | 1.35 | ◯ | ◯ | Good | |
| 1 | | | | | | | | | | | | |
| Example | 3.1 | 6 | 3.5 | 2.9 | 40.0 | 1.45 | ◯ | 1.32 | ◯ | ◯ | Good | |
| 2 | | | | | | | | | | | | |
| Example | 2.1 | 7 | 2.6 | 1.9 | 48.0 | 1.46 | ◯ | 1.33 | ◯ | ◯ | Good | |
| 3 | | | | | | | | | | | | |
| Example | 5.0 | 6 | 8.1 | 9.5 | 28.0 | 1.51 | ◯ | 1.38 | ◯ | ◯ | Good: White | |
| 4 | | | | | | | | | | | spots appeared. | |
| Comp. | 1.6 | 7 | 1.2 | 0.8 | 65.0 | 1.5 | ◯ | —¹⁾ | X | — | Decrease in image | Titanium oxide |
| Ex. 1 | | | | | | | | | | | density after | was buried in |
| | | | | | | | | | | | printing 3,000 | the surface of |
| | | | | | | | | | | | sheets of paper | toner particles |
| Comp. | 1.1 | 7 | 0.6 | 0.1 | 72.0 | 1.51 | ◯ | —²⁾ | X | X | Blurring occurred | Titanium oxide |
| Ex. 2 | | | | | | | | | | | after printing | was buried in |
| | | | | | | | | | | | 3,000 sheets of | the surface of |
| | | | | | | | | | | | paper | toner particles |
| Comp. | 5.8 | 6 | 13.6 | 12.5 | 16.0 | 1.5 | ◯ | 1.32 | ◯ | X | Blurring occurred | White spots |
| Ex. 3 | | | | | | | | | | | | appeared in the |
| | | | | | | | | | | | | image due to |
| | | | | | | | | | | | | titanium oxide |
| Comp. | 4.7 | 5 | 7.5 | 7.3 | 22.0 | 1.53 | ◯ | 1.24 | X | X | Blurring occurred | |
| Ex. 4 | | | | | | | | | | | | |

¹⁾Since image density went down to 1.0 after printing 3,000 sheets of paper, the test was suspended.
²⁾Since image deletion occurred after printing 3,000 sheets of paper, the test was suspended.

As is clear from Table 2, in Examples 1 to 4, a good image was obtained even after a long period of printing test. In Example 4, a small number of white spots appeared in the image evaluation patterns but they were no problem from a practical viewpoint. By contrast, in Comparative Example 1 where titanium oxide had a smaller aspect ratio than a predetermined value and was rutile type, the effect of added titanium oxide was not fully achieved and the image density after printing 3,000 sheets of paper went down to 1.0. Therefore, the test was suspended.

In Comparative Example 2 where the aspect ratio of titanium oxide was smaller than a predetermined value, image deletion occurred after printing 3,000 sheets of paper and therefore the test was suspended. The possible reason for this is that titanium oxide was buried in toner and as a result, it was impossible to polish the surface of photoreceptors. In Comparative Example 3 where the aspect ratio of titanium oxide was larger than a predetermined value, image deletion occurred. This is possibly because titanium oxide was separated from the toner surface and consequently, the effect of polishing the surface of photoreceptors was not fully achieved. In addition, white spots appeared in the image due to titanium oxide separated from toner. In Comparative Example 4 where the Mohs hardness of titanium oxide was smaller than a predetermined value, the effect of polishing the surface of photoreceptors was not fully achieved and image deletion occurred.

(Rates of Free Titanium Oxide and Free Toner Particles)

Next, using two-component developers obtained in Examples 1 to 4 and Comparative Examples 1 to 4, the rate of free titanium oxide and the rate of free toner particles were measured to evaluate whether titanium oxide was separated from the toner surface or buried in toner particles. These rates were measured with a particle analyzer (“DP-1000” manufactured by Horiba, Ltd.).

Specifically, “rate of free titanium oxide” was calculated by measuring with a particle analyzer the emission frequency of a Ti atom derived from titanium oxide and the emission frequency of a Ti atom that emits light simultaneously with a carbon atom which is a constituent element of the binder resin and applying each value so obtained to the following formula (II).

As described above, “rate of free toner particles” was obtained by drawing up the distribution chart of equivalent particle size of toner particles and calculating the ratio of the toner particles to which no titanium oxide adheres to all toner particles.

These rates were measured when the printing of 100,000 sheets of paper was finished. In the criterion for evaluation, the case where the rates of both free titanium oxide and free toner particles were not more than 10% was viewed as no problem. The results are presented in Table 2.

As is clear from Table 2, in Examples 1 to 4 and Comparative Example 4, the rates of both free titanium oxide and free toner particles were not more than 10%. On the other hand, in Comparative Examples 1 and 2, while the rates of free titanium oxide were not more than 10%, the rates of free toner particles were over 10%, respectively reaching 12.3% and 14.7%. In Comparative Example 3, while the rate of free toner particles was not more than 10%, the rate of free titanium oxide was 13.6%.

(Degree of Burial)

Then, using the two-component developers obtained in Examples 1 to 4 and Comparative Examples 1 to 4, the degree of burial was measured in terms of whether titanium oxide was buried in toner particles or not. Specifically, using a SEM and an energy dispersive X-ray analyzer under the above-mentioned conditions, X1 and X2 were measured and the measured values were applied to the above formula (III) to make a calculation. The results are presented in Table 2.

As apparent from Table 2, contrary to Comparative Examples 1 and 2, Examples 1 to 4 and Comparative Examples 3 and 4 had an acceptable value.

It is further understood by those skilled in the art that the foregoing description is a preferred embodiment of the disclosed toner and that various changes and modifications may be made in the invention without departing from the spirit and scope thereof.

What is claimed is:

1. An electrophotographic toner, comprising toner particles containing at least a binder resin, wax, a charge control agent and a pigment, and at least titanium oxide externally added to the toner particles as an external additive,
wherein the titanium oxide has an aspect ratio of 2 to 5 and a Mohs hardness of not less than 6.

2. The electrophotographic toner according to claim 1, wherein the titanium oxide is a compound oxide doped with a metal of the group V of the periodic table.

3. The electrophotographic toner according to claim 2, wherein the metal of the group V of the periodic table is at least one selected from vanadium and niobium.

4. The electrophotographic toner according to claim 1, wherein the titanium oxide is a compound oxide doped with a metal of the group V of the periodic table in an amount of not less than 1 mol % to less than 10 mol % to the total amount of titanium oxide.

5. The electrophotographic toner according to claim 1, wherein the titanium oxide is anatase-type.

6. The electrophotographic toner according to claim 1, wherein the aspect ratio is a ratio of a major axis to a minor axis, the major axis is 0.010 to 0.150 μm and the minor axis is 0.002 to 0.050 μm.

7. The electrophotographic toner according to claim 1, wherein the rate of free titanium oxide and the rate of free toner particles are respectively not more than 10%.

8. The electrophotographic toner according to claim 1, wherein a degree of burial of titanium oxide in the toner surface is not more than 50%.

9. The electrophotographic toner according to claim 1, wherein the amount of the titanium oxide to be externally added is 0.2 to 5.0 parts by weight to 100 parts by weight of toner particles.

10. An electrophotographic toner, comprising toner particles containing at least a binder resin, wax, a charge control agent and a pigment, and at least titanium oxide externally added to the toner particles as an external additive,
wherein anatase-type titanium oxide having an aspect ratio of 2 to 5 and a Mohs hardness of not less than 6 is prepared by preparing a peroxotitanic acid solution using titanium powder, adding a metal of the group V of the periodic table as a doping metal to the solution, then obtaining peroxo-modified anatase sol through hydrothermal treatment at 80 to 100° C. for 7 to 15 hours and drying the sol.

11. The electrophotographic toner according to claim 1, which is used for an image forming apparatus having amorphous silicon photoreceptors.
